(19) United States
(12) Patent Application Publication
(10) Pub. No.: US 2004/0039651 A1
(43) Pub. Date: Feb. 26, 2004

(54) Method for securing a transaction on a computer network

(76) Inventors: Stefan Grunzig, Kranzberg (DE); Tschangiz Scheybani, Munchen (DE)

Correspondence Address: BACON & THOMAS, PLLC, 625 SLATERS LANE, FOURTH FLOOR, ALEXANDRIA, VA, 22314

(21) Appl. No.: 10/362,367

(22) PCT Filed: Sep. 13, 2001
(86) PCT No.: PCT/EP01/10606

(30) Foreign Application Priority Data
Sep. 14, 2000 (DE) 100459242

(51) Int. Cl. G06F 17/60

(52) U.S. Cl. 705/26

(57) ABSTRACT

A method is described for protecting a transaction over a computer network by which a one-time transaction password is transmitted to a service user and transmitted by the service user to a service provider over the computer network to confirm the transaction. The transaction password is transmitted over a mobile network to the service user's mobile communication terminal.

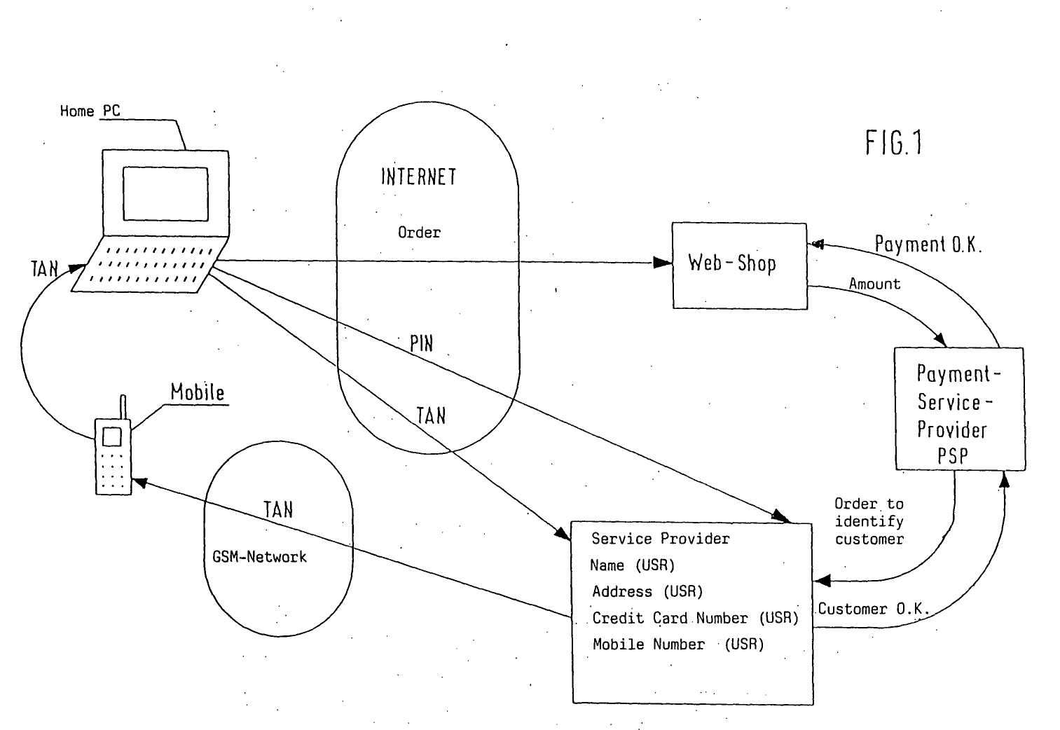

This invention relates to a method for protecting a transaction on a computer or similar network, for example the Internet or a large in-house Intranet, by which a one-time transaction password is transmitted to a service user and transmitted by the service user to a service provider over the computer network to confirm the transaction.

Such a method is currently used for example in the usual online banking method. The bank customer is sent, besides the PIN, additional transaction numbers, so-called TANs, that can be used only for one transaction each and then lose their validity. The transaction is only performed if the PIN and TAN match values deposited with the online banking provider. Since the TAN is only used once, unauthorized persons who succeed in spying out the data transfer between bank and customer are prevented from committing abuse with the determined data. The TAN thus offers additional security for the customer since it considerably reduces such abuse of the online banking connection. Secondly, it also offers additional security for the online banking provider since the interaction of correct PIN and correct TAN confirms the customer's authenticity. Such methods known from online banking are of course also applicable for effecting transactions in connection with other business on the Internet, for example purchasing goods.

To prevent unauthorized persons from gaining possession of the TAN while it can still be used for a transaction, the TAN has hitherto been sent to the customer by letter under suitable security conditions. Due to the considerable effort and duration of postal delivery, a plurality of valid TANs, for example 40 different TANs, at a time are usually sent to the customer, being associated with the customer's particular PIN. The customer must keep the 40 TANs in a safe place and can use each of the TANs once. As soon as the customer has used up all the TANs he can order new TANs from his bank.

Obviously, it is extremely inconvenient to manage such TANs, particularly for the customer. It is normally possible to store the received TANs in the customer's computer using suitable software. When effecting a transaction. one of the stored TANs is automatically used by the online banking program and then marked as erased. That is, PIN and TAN are transmitted automatically at the correct time within a transaction without the customer having to intervene directly. However, storage of TANs and/or PIN involves the considerable danger of these sensitive data being spied out on the customer's computer by unauthorized persons, for example through so-called “Trojan horses” or similar programs, and then used abusively. The safer alternative is for the customer not to store the TANs on his computer but to keep them in a safe place in written form instead. But since it is normally impracticable for the customer to remember several of these TANs, this simultaneously means that the customer must carry TANs in written form with him if he wants to do his banking business from different places and computers. Moreover, this keeping of TANs also involves the possibility of them being stolen from the customer for example, or being lost and falling into unauthorized hands.

U.S. Pat. No. 5,809,144 states a method for selling and delivering goods on the Internet wherein, for protecting customers and merchants from each other and protecting data from interception and abuse, a method is proposed that includes transmission of a plurality of cryptographic checksums and a signature. However, this method is extremely elaborate and computing-intensive.

It is the problem of the present invention to provide an alternative to the stated prior art that permits protection of a transaction, for example a payment transaction, over a computer network or network suitable for exchanging data (e.g. use of the Internet over mobile phone) in simple and safe fashion.

This problem is solved by a method according to claim 1. The dependent claims contain advantageous developments and embodiments of the inventive method.

In the inventive method, a one-time transaction password is likewise transmitted to the service user, i.e. the customer, who transmits it back to a service provider over the computer network to confirm the transaction for making a payment. The transaction password can be any password. Preferably, it is a number, i.e. a usual TAN. To increase security, the service user's personal data are checked before a transaction password is transmitted to him. These data are primarily those required for the transaction, for example the service user's name, address, credit card number and mobile phone subscriber number of the communication terminal. Besides these data further data can of course be registered, alternatively or in addition to the service user's name and address, for example an ID or passport number.

The transaction password serves as in the cases stated at the outset to protect the service user and authenticate the service user vis-à-vis the service provider. It is used only once for one transaction and then loses its validity. The transaction password is compared by the service provider with a transaction password stored there and the transaction effected only in case of a match, i.e. if the correct transaction password is returned. Transmission of the transaction password to the service user is not effected over the computer network but over a mobile network to the customer's mobile communication terminal. The mobile network can be any mobile network, for example GSM or UMTS. The term “mobile network” here also includes corresponding pager networks. The mobile communication terminal is for example a commercial mobile phone, a pager or a PDA with a corresponding mobile phone function.

The service user can receive the transaction password directly from the service provider. It is of course also possible for the transaction password to be transmitted to the service user from another place, for example a credit card organization or a mobile network provider that is associated with the service provider. What is crucial is that here, unlike in abovementioned U.S. Pat. No. 5,809,144, the security-sensitive data that the service user is to send to the service provider over the computer network to confirm a transaction are not transmitted over the same network, but a completely different route is used for sending the transaction password to the service user. This considerably increases security since abuse by an unauthorized person no longer requires only knowledge of the service user's name, address, etc., but also possession of the service user's communication terminal.

Since in the inventive method transmission of the transaction password is fast and uncomplicated, unlike transmission by special mail as in the conventional online banking method, it is possible for the transaction password to be transmitted to the service user directly during or immediately before a transaction. That is, it is no longer necessary for a plurality of numbers to be transmitted in advance. Thus, it is also no longer necessary for the service user to keep a plurality of numbers safely so as to have the number at hand at the suitable time. This simultaneously excludes the possibility of unauthorized persons gaining possession of a block of TANs.

For checking these data, a consistency check is then performed between the service provider, a mobile network provider and a credit card company, i.e. the service provider performs a check of the data for example by a data base query with the mobile network provider and a simultaneous data base query with the credit card company. It thus ensures that the mobile phone subscriber number and the credit card number belong to the same service user. Simultaneously, a query can of course also be made about the service user's solvency through the credit card.

Only after a successful consistency check of the service user data, the service is finally enabled, and a transaction password is transmitted to the service user with which he can finally effect the transaction.

Since transmission of all service user data and a corresponding consistency check by the service provider during each single transaction are relatively elaborate, a first-time transaction is preferably preceded by a registration process in which at least part of the service user data is transmitted to the service provider. The check of the service user data, for example the complete consistency check, is immediately effected. Upon successful registration the service user is finally sent a personal identification number, hereinafter referred to as a PIN, which is associated with this service user. At a later transaction the PIN is first transmitted by the service user to the service provider, thereby automatically informing the latter of the current service user's data. The service provider preferably only checks the PIN instead of the complete service user data. It is of course also possible for the service user to input his data together with the PIN again at every session and for both the service user data and the PIN to be checked. The personal identification number can be transmitted for example—like the transaction password—over a mobile network to the customer's mobile communication terminal.

In a further preferred example, the service user transmits service user data to the service provider while stating the PIN, said data being used in following transactions. This is a second registration step, so to speak, in which the service provider is sent the service user data that it did not receive at the first registration. Alternatively, it is naturally also possible to change service user data in this way, for example if the service user wants to use a different communication terminal with a mobile phone subscriber number or wants to use a different credit card with a different credit card number for payment.

It is of course possible to enter different credit card numbers, for example from different credit card companies, or a plurality of different mobile phone subscribers, for example of different communication terminals, at each registration. The service user can then choose from the various possibilities anytime when utilizing the service later.

Transmission of the service user data and/or PIN over the computer network is preferably effected in safe fashion, i.e. using a secure channel, for example the SSL method, by which these sensitive data are transmitted in encrypted form.

The transaction password or personal identification number is preferably transmitted to the service user's mobile communication terminal as a text message, for example by SMS. This method is extremely cost-effective since it requires a low data signaling rate. The service user can read the PIN or transaction password off the display of his communication terminal in plaintext and enter it at the corresponding place in an input mask on his PC.

In a preferred example, the service user receives the PIN from a mobile network provider or associated service provider. The mobile network provider or associated service provider already knows the service user's name, address and mobile phone subscriber number. Stating this PIN, the service user then transmits to the service provider a credit card number that is used in following transactions. The service provider checks the PIN by comparison with the PIN that it likewise received from the mobile network provider or associated service provider together with the personal data, and assigns the credit card number to these data and/or performs a corresponding consistency check by a data base query with the relevant credit card organization. Alternatively, it is of course also possible for the service operator to forward the received PIN only to the mobile network provider or associated service provider for a check and to get back from it only the information that the data are in order. In case of a successful check the service is enabled and can be used by the service user anytime. The service works in this case only with the mobile phone subscriber number by which the user is originally known to the mobile network provider. The credit card number can be altered by the service user anytime with this method.

In an alternative method, the PIN is transmitted by a credit card organization or associated service provider to the service user. In this case the service user can perform the registration with the service provider with the received PIN and state his mobile phone subscriber number at the same time. A check of all data is also effected first here, as in the prior case. Then the service is enabled, whereby in this case the service only works in connection with the initially known credit card number under which the service user is also registered with the credit card organization that transmitted the PIN. The mobile phone subscriber number can be altered by the service user anytime by new registration with the PIN.

The inventive method for protecting transactions can be used in any operations. It can be used for example directly in online banking. Furthermore, it can be used for purchases over the Internet and the following payment. The service provider need not necessarily be identical with the Internet shop operator here. There must only be a corresponding—direct or indirect—connection between service provider and shop operator, i.e. shop operator and service provider are contractual partners for example or connected via a common contractual partner. The service provider can for example also be the credit card organization or the mobile network provider itself. However, it can also be a completely independent organization that has a business connection with the various other organizations and operators.

The inventive method furthermore offers the possibility of further information being transmitted with the transaction password and/or PIN to the service user's mobile communication terminal. Such additional information can be for example current information about the service itself. But it can also be advertising or the like. In this case it is for example possible to finance the service via the advertising sent with the transaction password or PIN, so that no additional costs arise for shop operators, service user, involved credit card organization or mobile network provider.

Since the messages are transmitted over a mobile network to a mobile communication terminal, the method is extremely flexible, i.e. the service user does not have to effect transactions from his own PC at a fixed location but can use any available computer. The inventive method is consequently employable wherever the customer is reachable with his mobile communication terminal, i.e. also internationally wherever roaming is possible if a mobile phone is used. No special infrastructure such as a smart-card terminal is required at the computer being used by the customer.

The total method of customer registration, transmission of identification numbers and transaction passwords and check of the different data can be effected in fully automatic fashion over a suitable computer, for example a server of the service operator, on which a corresponding computer program is implemented.

The invention will be explained again hereinafter with reference to concrete examples.

In the following examples it will be assumed that the transaction password is a number, i.e. a TAN. Furthermore it will be assumed that transmission of the different TANs and the PIN is effected by SMS to the service user's mobile phone. Likewise, the eventual payment will always be made by the service user's credit card, the service user's credit card being charged by the service provider in a commonly known, usual way. The invention is of course not limited to these concrete examples.

The first example involves a spontaneous purchase by a service user not yet registered with the service provider.

Making a safe credit card payment here too presupposes a consistency check of the service user data, namely the service user's credit card number, mobile phone number as well as address and name. This consistency check is effected between service provider, mobile network provider and credit card organization.

While shopping on the PC and after activating a payment process, the service user is directed to the service operator's Internet server or Web site. Here the service user enters in a corresponding dialogue mask on his PC his credit card number and mobile phone number, which are transmitted to the server by safe transmission, for example by SSL. Name and address can likewise be inputted and transmitted as well. However, the data have normally already been stated on the Internet shop Web site since these data are also required for delivering the goods. These data can therefore also be forwarded to the service operator directly by the shop operator when the service user is directed to the service operator's Internet server or Web site.

The service provider then performs the necessary check of all service user data by a corresponding data base query with the mobile phone operator and a simultaneous data base query with the credit card company. In case of a positive query result, the service is enabled and the service user is sent a one-time TAN for this payment process by SMS to his mobile phone. The service user then enters the TAN in a corresponding input mask on the PC. Finally, the TAN is sent from the PC to the background system, for example the service operator's Internet server. The TAN sent to the service user is then compared with the TAN deposited there. In case of successful comparison, the service user's credit card account is charged. The service user himself receives confirmation of the successful credit card payment.

In the second example, it will be assumed that the service user is already registered with the service provider and received a unique PIN in the course of the registration process.

The registered service user logs into the service operator's Internet server by his PIN over a safe channel while shopping on the PC. The PIN is then checked by the service operator and service enabled for the current session. The service user then has for example the possibility of putting together a shopping cart within an Internet shop. When the shopping cart has been put together, the service user need then only activate the payment process, for example by a button on the service provider's Web site. The TAN is then immediately transmitted to the service user's mobile phone. Here, too, the TAN is then inputted in an input mask by the service user on the PC and transmitted back over the computer network. After successful comparison of the TAN, the service user's credit card account is charged, and the successful credit card payment confirmed.

It is of course possible for the service user to choose from different credit card companies that he has credit cards from. This can be queried within an input mask on the service provider's Web site. This possibility exists even in the case of previous registration if the service user stated the different credit card companies with the corresponding credit card numbers at registration. A choice can likewise be made between different mobile phones with different mobile phone numbers if this was previously stated at registration.

There are likewise several alternatives for registration, four different examples being stated hereinafter.

In the first version, the service provider already knows the service user as a credit card holder, i.e. it knows name, address and credit card number. This is the case for example when the service operator is itself the relevant credit card organization or has a business connection and exchanges the data therewith.

In this case the service user is sent a PIN for utilizing the service from his credit card organization or an associated service provider. The service user can use this PIN to log into the service provider's server and can input his mobile phone number for utilizing the service. The service is thus enabled. The service only works with the credit card number that is already known to the service provider. The mobile phone number can be altered anytime by logging in again and entering the PIN.

In the second version, the service provider already has personal information about the service user as a mobile phone user, i.e. the service provider knows name, address and mobile phone number. This is the case for example when the service operator is itself the mobile network operator or is associated therewith.

In this case the service user receives the PIN for utilizing the service from his mobile network operator or an associated service provider. The service user again uses the PIN to log into the service provider's server and inputs his credit card number for utilizing the service. In this case the service works only with the mobile phone subscriber number already known to the service provider. The credit card number can again be altered anytime by inputting the PIN.

In a third version, registration is done in a mobile phone store. Name, address and mobile phone number are likewise registered, and the service user is given a PIN letter for example. Such registration can also be done with the mailcarrier or at the post office. The service user can use the delivered PIN to log into the service provider's server and again input his credit card number for utilizing the service. Then, too, the service is effected only with the initially registered mobile phone number.

This third alternative of course also involves the possibility of the credit card number with the relevant credit card organization being registered for example with the mailcarrier or at the post office instead of the mobile phone number, and the mobile phone subscriber number then stated and optionally altered by means of the PIN.

The fourth example of registration is strictly online registration.

Strictly online registration again presupposes a consistency check of the stated service user data between the service provider, relevant mobile network provider and credit card organization.

The service user logs into a special registration Web page of the service provider and states name, address as well as credit card number and mobile phone subscriber number there. The service provider then performs a check of the service user data by a data base query with the mobile network provider and a data base query with the credit card company. Only in case of positive query results the service is enabled and the service user receives a PIN for utilizing the service. This PIN can be transmitted by any route, for example by mail. However, this PIN transmission is preferably likewise effected over the mobile network to the mobile phone under the entered mobile phone number. Transmission of the PIN can likewise be effected by SMS. This method has the advantage that the service user need not wait for delivery of a letter, but transmission of the PIN can be effected immediately after online registration so that the service is available to the service user right away.

With reference to the Figure a further example of utilization after previous registration will be described in the following, whereby in this special example the Internet shop (Web shop) is not in direct contact with the service provider but has a further service provider, a payment service provider (PSP) here, therebetween.

Here, too, the service user first logs into the desired Web shop over the Internet and places an order. To collect the amount due, the Web shop sends the amount for example together with the service user's name and address to the payment service provider. The latter finally gives the service provider an order for customer identification. Simultaneously the service user is automatically directed to the service provider's Web site. Here, the user must first state the PIN to enable the payment service. Then the service user's data or PIN are checked for consistency and also compared with the data received from the payment service provider. After a successful check, the service provider sends a TAN over the GSM network to the mobile phone of the service user, who reads the TAN off the display on the mobile phone and inputs it at the corresponding place in an input mask on his PC to confirm the transaction. The TAN is then sent to the service provider over the Internet for a check. Upon a successful check of the TAN, a “Customer O.K.” signal is transmitted to the payment service provider. The payment service provider finally ensures that the amount is collected from the service user's credit card account and acknowledges successful payment to the Web shop with a “Payment O.K.” signal.

1. A method for protecting a transaction over a computer network by which a one-time transaction password is transmitted to a service user and transmitted by the service user to a service provider over the computer network to confirm the transaction, the transaction password being transmitted over a mobile network to the service user's mobile communication terminal, characterized in that a check of personal service user data is effected before transmission of the transaction password to the service user.

2. A method according to claim 1, characterized in that the transaction password is transmitted to the service user during or immediately before a transaction.

3. A method according to either of claims 1 to 2, characterized in that at least part of the service user data is transmitted to the service provider over the computer network during a transaction by the service user.

4. A method according to any of claims 1 to 3, characterized in that at least part of the service user data is transmitted to the service provider in a first registration process before a first-time transaction and these service user data are checked and a personal identification number associated with the service user is transmitted to the service user when registration is complete and the personal identification number is transmitted to the service provider by the service user at a transaction and the personal identification number is checked by the service provider together with or instead of the service user data.

5. A method according to claim 4, characterized in that the personal identification number is transmitted over a mobile network to the service user's mobile communication terminal.

6. A method according to claim 4 or 5, characterized in that the service user transmits service user data to the service provider while stating the personal identification number, said data being used in following transactions.

7. A method according to any of claims 2 to 6, characterized in that the service user data include a name and/or an address and/or a credit card number and/or a mobile phone subscriber number of the service user.

8. A method according to claim 6 or 7, characterized in that the service user is sent the personal identification number by a mobile network operator or associated service provider, and the service user transmits a credit card number to the service provider while stating the personal identification number, said credit card number being used in following transactions.

9. A method according to claim 6 or 7, characterized in that the service user is sent the personal identification number by a credit card organization or associated service provider, and the service user transmits a mobile phone subscriber number to the service provider while stating the personal identification number, said subscriber number being used in following transactions.

10. A method according to any of claims 1 to 9, characterized in that the service user data and/or personal identification number are transmitted over the computer network in secure fashion.

11. A method according to any of claims 1 to 10, characterized in that the transaction password or personal identification number is transmitted as a text message.

12. A method according to any of claims 1 to 11, characterized in that additional information is transmitted to the service user's communication terminal with the transaction password and/or personal identification number.
